(19) United States
(12) Patent Application Publication
(10) Pub. No.: US 2010/0017020 A1
(43) Pub. Date: Jan. 21, 2010

(54) Sorting system

(76) Inventors: Bradley Hubbard-Nelson, Concord, MA (US); Don Sackett, Bedford, MA (US); John Francis Egan, Middleton, MA (US)

Correspondence Address: IANDIORIO TESKA & COLEMAN;INTELLECTUAL PROPERTY LAW ATTORNEYS, 260 BEAR HILL ROAD, WALTHAM, MA, 02451-1018, US

(21) Appl. No.: 12/218,512

(22) Filed: Jul. 16, 2008

(51) Int. Cl. B65G 43/08; G06F 17/00

(52) U.S. Cl. 700/230; 198/358

(57) ABSTRACT

A sorting system and method with a conveyance for transporting items to be sorted at a predetermined speed. An XRF spectrometer subsystem includes at least one x-ray source directing x-ray energy at an item carried by the conveyance and a detector responsive to x-rays emitted by the item and producing a spectral signal characterizing a leading edge of the item and a trailing edge of the item. A diverter subsystem downstream of the XRF subsystem is for diverting sorted items. An electronic processing subsystem is responsive to the detector signal and is configured to determine if the item is to be diverted based on the elemental makeup of the item from its x-ray spectrum. The same processing subsystem is also configured to calculate the position of the item on the conveyance based on the detector signal and together with the predetermined speed of the conveyance controlling the diverter subsystem to divert selected items.

### FIELD OF THE INVENTION

This invention relates to sorting systems, and in one particular embodiment, to a scrap metal sorting system.

### BACKGROUND OF THE INVENTION

Sorting systems are used to divert undesirable items in a waste stream from the desirable items. Some systems are automatic or semiautomatic and employ x-ray technology to classify the various items. See, for example, U.S. Pat. Nos. 6,266,390; 6,519,315; and 6,888,917. Other similar systems are disclosed in U.S. Pat. Nos. 5,663,997; 4,848,590; 5,236,092; 5,314,072; 5,260,576; and European Patent No. EPO 096092.

In some industries, sorting is still performed manually. For example, in the scrap metal industry, vehicles, washers, dryers, and other large items are shredded and then a magnet is used to retrieve steel (the “ferrous” fraction) from the shredded waste. The steel is then melted down for recycling. The problem is that items like electric motors present in the waste stream include both steel and copper and these “meatballs” are attracted to the magnet. If copper is added to the melt, the quality of the melt is severely reduced as copper weakens the resulting recycled steel. Another example is for scrap metal resulting from automobile shredding. In this case, the mixed “non-ferrous” metal consists of low-density metals such as aluminum and magnesium and “heavies”—high density metals such as iron, copper, zinc, lead and stainless steel. Another sorting application is to remove specific high value metals such as copper or stainless from a mixture of heavies. Currently this type of sorting is either non-specific, that is, “lights” are separated from “heavies” (using induction sorting or x-ray transmission (XRT)), or the material is sold mixed and is later manually sorted typically in countries with lower labor costs.

So, workers manually examine the items from the ferrous stream as they travel on a conveyor and discard any meatballs. The result is a labor intensive, less accurate process, and the possibility that mistakes are made in which case copper or other undesirable elements contaminate the melt. In other cases, the material is exported without being sorted (in the case of automobile shredding, as an example) or manual picking stations are used (in the case of meatballs). In cases of glass or plastic, there is often no removal of undesirables performed because the material of interest cannot be visually identified, or it is not economically feasible to do so even in low labor cost regions.

Existing manually operated x-ray florescence (XRF) analysis techniques have not been successfully adapted for high volume, automated scrap metal sorting. However since the early 1980s portable XRF instruments have been used very successfully to sort scrap metal via manual operation. For example, Metorex produced the X-Met 880 in 1988 that used EDXRF technology, where operators could stand at a conveyor belt and manually test pieces of scrap to obtain an XRF spectrum and alloy analysis, often with test times as fast as 0.5 seconds. The sorting environment is extremely harsh and dirty, the shredded waste varies in size, mass, and composition, and any viable system would have to cost less and have a reliability and exhibit a throughput greater than the existing manual picking process. Adapting an x-ray system to replace the manual process includes several technological challenges.

First, the desired throughput requires a conveyor carrying the scrap to be sorted traveling at speeds as fast as four to five feet per second. Analyzing the scrap items traveling at such high speeds can be very difficult. Piece sizes vary from sizes as small as 1 cm (0.5″) up to 12.5 cm (5″) or as large as 20 cm (8″) for meatball applications and, in order to achieve accurate sorting, any automated XRF system must be designed to examine single pieces moving along the conveyor.

Because these pieces can differ significantly in size and weight, it is desirable to know the piece location on the conveyor as accurately as possible so that downstream diversion can be performed accurately. To further increase throughput, it is also desirable that the conveyor not be limited to a single sequential line of items. Moreover, since the meatballs to be diverted can range in size and weight (e.g., between one to fifteen pounds), care must be taken to properly divert these different size and weight items at exactly the right time. For example, if diverting paddles are used, a concern arises if the force used to strike a fifteen pound item is the same as the force used to strike a one pound item. There are two sources of possible error. One is detection accuracy, the other is diversion accuracy. Both are largely independent, so for example to achieve 95% accuracy of sorting out certain materials (e.g. meatballs), a 97.5% detection accuracy and 97.5% diversion accuracy are required since independent probabilities are multiplicative. The “detection accuracy” is that the XRF system may not detect enough x-rays to make a statistically significant decision that a certain type of metal is present. The “diversion accuracy” is that the downstream diverter may not fire at the right time in which case the piece will not be diverted. Some existing systems use external sensors to determine the location of the scrap piece on the conveyor.

One goal of the subject invention is a method whereby the piece of material may be located precisely so its position is known on the conveyor with good accuracy. It can then be known accurately when it has arrived at the diverter and thus when to fire the diverter to achieve maximum diversion.

### BRIEF SUMMARY OF THE INVENTION

It is therefore an object of this invention to provide a new automatic sorting system and method.

It is a further object of this invention to provide such a system and method which is particularly useful in the scrap metal industry.

It is a further object of this invention to provide such a sorting system and method which automates the present manual process.

It is a further object of this invention to provide such a sorting system and method which operates reliably.

It is a further object of this invention to provide such a sorting system and method which exhibits a high throughput.

It is a further object of this invention to provide such a sorting system and method which is more accurate.

The subject invention results from the realization that a new sorting system particularly well adapted for use in the scrap metal industry employs an XRF spectrometer subsystem which both analyzes the scrap to determine which items include copper or other metals and thus are to be diverted from the main waste stream and wherein the same XRF spectrometer subsystem is also used to determine the position and even the size and mass of each piece of scrap to be diverted to better control the diverter subsystem thereby reliably maintaining the desired makeup of the waste stream. Typically, the sorting system of the subject invention includes multiple lanes across the conveyor for a very high throughput and each such lane includes a detector, a high speed digital processor, and a diverter all linked together. In some cases the lanes are segregated by physical dividers, while in other cases the lanes are “virtual lanes” defined by the arrangement of detectors. In these cases the position of pieces is determined by combining signals from one or more detector channels.

This invention features a sorting system comprising a conveyance for transporting items to be sorted at a predetermined speed. An XRF spectrometer subsystem includes at least one x-ray source directing x-ray energy at an item carried by the conveyance and a detector responsive to x-rays emitted by the item and producing a spectral signal characterizing a leading edge of the item and a trailing edge of the item. A diverter subsystem downstream of the XRF subsystem is for diverting sorted items. An electronic processing subsystem is responsive to the detector signal land is configured to determine if the item is to be diverted based on the elemental makeup of the item from its x-ray spectrum. The processing subsystem may use a programmable logic based processor to calculate the position of the item on the conveyance based on the detector signals and together with the predetermined speed of the conveyance controls which diverter channels are fired and when to efficiently divert selected items.

The electronic processing subsystem may further be configured to estimate the mass of the item. In one example, the mass is estimated based on the size of the item which is estimated based on the leading and trailing edges of the item defining the extent of the item. The diverter subsystem may be configured to apply variable forces to items on the conveyance. In such an example, the electronic processing subsystem may be further configured to control the force applied by the diversion subsystem to an item based on its mass.

In one example, the conveyance includes multiple virtual lanes for increasing the throughput of the system and there is a diverter for each lane, a detector for each lane, and an electronic processing subsystem for each lane.

One sorting system in accordance with the subject invention features an XRF analyzer subsystem configured to detect fluoresced x-rays from an item being conveyed and to classify the item based on its fluoresced x-rays. An electronic processing subsystem is responsive to the XRF analyzer subsystem and is configured to determine the extent of the item from its fluoresced x-rays and to activate a diverter subsystem based on the classification at a time based in part on the extent of the item. The electronic processing subsystem may be further configured to estimate the mass of the item based on its extent to actuate the diverter subsystem based on the mass of the item.

One sorting system includes a conveyor with multiple pieces of scrap metal thereon traveling in parallel with each other, multiple diverters each defining a lane of the conveyor, an XRF analyzer associated with each lane configured to detect fluoresced x-rays, and an electronic processing subsystem associated with each lane and responsive to the XRF analyzer subsystem and configured to determine the extent of the item from its fluoresced x-rays and to activate a diverter based on the classification at a time based at least in part on the extent of the item.

The subject invention also features a sorting method comprising conveying items to be sorted at a predetermined speed, directing x-ray energy at an item being conveyed, detecting x-rays emitted by the item and producing a spectral signal characterizing a leading edge of the item and a trailing edge of the item, determining if the item is to be diverted based on its elemental make up determined from its x-ray spectrum, calculating the position of the item being conveyed based on its x-ray spectrum together with the speed it is traveling, and controlling one or more diverters to divert select items. The method may further include the step of estimating the mass of the item. The preferred method includes transporting items in parallel multiple virtual lanes.

One sorting method includes detecting fluoresced x-rays from an item being conveyed, classifying the item based on its fluoresced x-rays, determining the extent of the item from its fluoresced x-rays, and diverting select items based on their classification and at a time based at least in part on their extent.

An exemplary sorting method in accordance with the subject invention features conveying multiple pieces of scrap metal in parallel on a conveyor, associating an XRF analyzer with each lane of the conveyor and classifying each item in each lane based on its fluoresced x-rays, determining the extent of each item in each lane from its fluoresced x-rays, and activating a diverter subsystem based on the classification and at a time based at least in part on the extent of the item.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic pictorial depiction of a prior art manual scrap metal sorting operation;

FIG. 2 is a highly schematic three-dimensional top view of an example of a sorting system and method in accordance with the subject invention;

FIG. 3 is a schematic block diagram showing the primary components associated with the XRF spectrometer subsystem of FIG. 2;

FIG. 4 is a flow chart depicting the primary steps associated with the operation of the high speed digital processor/analyzer of FIG. 3;

FIG. 5 is a schematic three-dimensional front view showing a particular embodiment of a sorting system in accordance with the subject invention;

FIG. 6 is a schematic three-dimension front view showing the primary components associated with the XRF spectrometer subsystem shown in FIG. 5;

FIG. 7 is a schematic three-dimensional front view showing in more detail the diverter subsystem of the sorter system shown in FIG. 5; and

FIG. 8 is another schematic three-dimensional front view of the sorter system shown in FIG. 7 wherein individual diverter paddles have been activated in accordance with the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

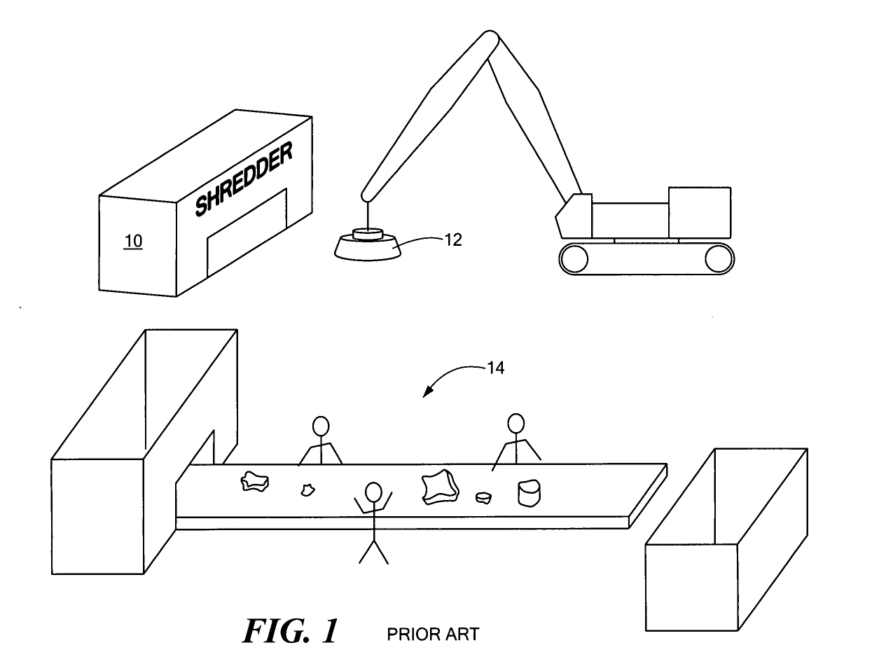

FIG. 1 shows a prior art sorting operation as described in the background section above wherein items are shredded in shredder 10 and the shredded metal waste is picked up by magnet 12 for delivery to manual sorting operation 14 where workers (“pickers”) remove “meatballs” from the waste stream. If these copper bearing meatballs are not removed, the resulting melt is contaminated. In such a manual system, the quality is irregular, and the cost is high owing to the need for the skilled workers or pickers who must constantly monitor the waste stream.

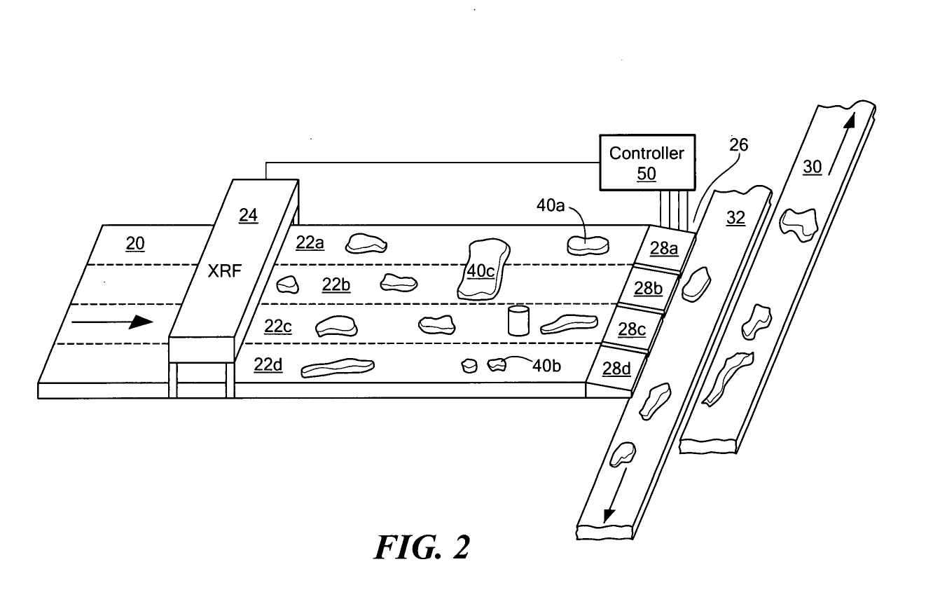

FIG. 2 schematically shows an example of a high throughput automatic system in accordance with the subject invention. Shredded metallic scrap is delivered to six foot wide conveyor belt 20 divided into multiple “virtual lanes” 22a-22d. One configuration is, for example, 18 virtual lanes each 4″ wide for a 72″ (6′) wide conveyor. Belt 20 may operate at speeds as high as 4 to 5 feet per second. XRF spectrometer subsystem 24 includes x-ray sources which direct x-ray energy at scrap items on belt 20. There may be one source per lane or a particular source may direct x-rays across the width of two or more lanes.

Preferably, there is one EDXRF detector per lane and associated with each detector is an electronic subsystem configured to determine the x-ray spectra of each scrap piece in that lane as it passes beneath the detector. The detector signal is also used to detect the leading edge of the piece and the trailing edge of the piece. That information can be used to estimate the extent of the item. The extent of the item can be used to determine its size and mass. In any case, the position of the item on the conveyor in the lane in known.

The result is a parallel processing sorting system with multiple independent lanes whereby material in each lane is independently analyzed by a processing subsystem which synchronizes the operation of the downstream diverter. High speed digital processing is used to acquire XRF spectra every 5-10 ms depending on the belt speed. When the spectra is acquired above a preset background threshold level, this indicates a piece of material is within the x-ray excitation region on conveyor 20 and the system acquires additional spectra in subsequent 5-10 ms time periods until an acquired spectrum is again not detectable above the background level. This stream of spectra is used to calculate an approximate center of mass of the piece of material (an averaging technique may be used) and the center of mass denotes the mean position of the piece of material on conveyor 20 at a given time.

The XRF spectra is also analyzed to determine the elements present in the piece from the relative concentrations based on the measured peak intensities of the spectra. Based on this data, a decision is made whether to divert the item. From the mean position and the speed of conveyor belt 20, the electronic subsystem determines when material arrives at diverter subsystem 26. Based on user criteria, the diverter either allows the material to pass onto conveyor 32 or diverts the material to secondary conveyor 30.

Thus, in one example, XRF subsystem 24 determines, for each lane, whether a piece contains copper (and thus constitutes a “meatball”) and also the position of that piece on belt 20. In this way, system 24 controls diverter subsystem 26 typically including paddles 28a-28d (one for each virtual lane) to flip meatballs onto conveyor belt 30. The rest of the scrap metal pieces are not flipped and instead proceed for further processing via conveyor belt 32.

In addition, the size of each piece can be established by XRF subsystem 24 as well as the density and mass of each piece. Thus, if paddles 28a-28d operate pneumatically, XRF subsystem 24 can control the force applied by the paddles so that meatballs of different mass are properly directed onto belt 30.

For example, if paddles 28a-28d are each triggered by controller 50 which applies variable air pressures delivered to the paddles, XRF subsystem 24 is programmed to signal controller 50 to apply a high to medium pressure to paddle 28a for larger high mass meatball 40a and to apply a lower pressure to paddle 28d for smaller lower mass meatball 40d. Similarly, XRF subsystem 24 signals controller 50 to apply the highest pressure available simultaneously to both paddles 28a and 28b for very large meatball 40c occupying lanes 28a and 28b.

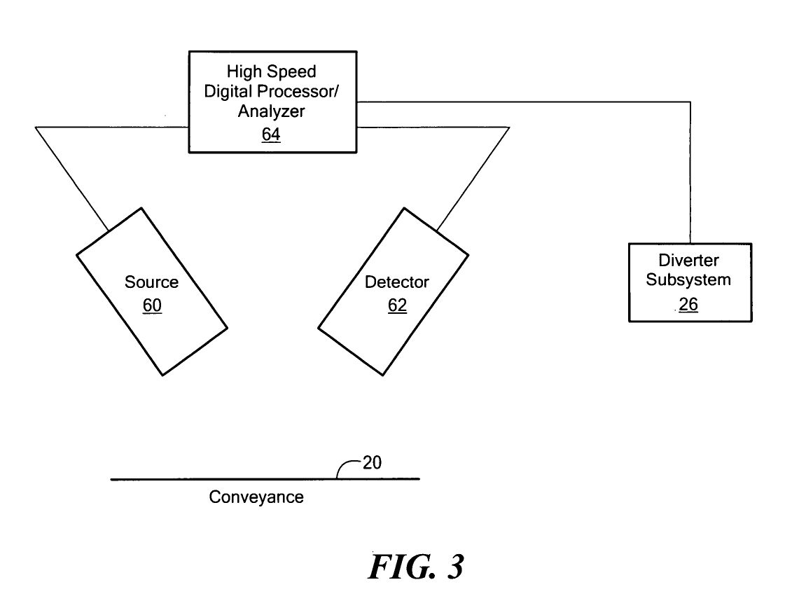

The result is a reliable high throughput system. Each lane 22a-22d preferably includes an x-ray source 60, FIG. 3, a detector 62, and a high speed digital processor 64 (e.g., a DSP or similar type processor which may include programmed logic) which controls source 60 and diverting subsystem 26 based on the spectral signal provided by detector 62. The XRF spectra is analyzed by high speed digital processor 64 to determine both the leading and trailing edges of a piece of material on conveyance 20 and also the elemental makeup of the item. High speed digital processors/analyzer subsystem 64 also includes an accurate internal clock for its operation and for the calculations involved in controlling diverter subsystem 26. The combination of a EDXRF plus high-speed DSP electronics system responsive to an x-ray detector and controlling a downstream diversion system enables the DSP to examine spectral snapshots every 5-10 ms inside a viewing area of the detector and to determine when a piece of material has moved into the viewing area and to thus determine the leading edge of the piece. The DSP then continues to collect spectral snapshots until the spectral analysis indicates the trailing edge of the piece of material is moving out of the viewing area (when the spectra appears like the bare conveyor). The system is programmed to then stop integrating spectral snapshots, and it calculates the approximate centroid of the piece of material from the detected front and back edge of the piece. Using this information, the system determines the position of the piece of material to about 1 cm or better, and from the belt speed and the collected spectrum, the system determines with very high accuracy if the piece should be diverted, and also when the piece will arrive at the diverter so one or more of the diverters of diverter 26 subsystem can be controlled to fire at the right time to yield a very high diversion accuracy.

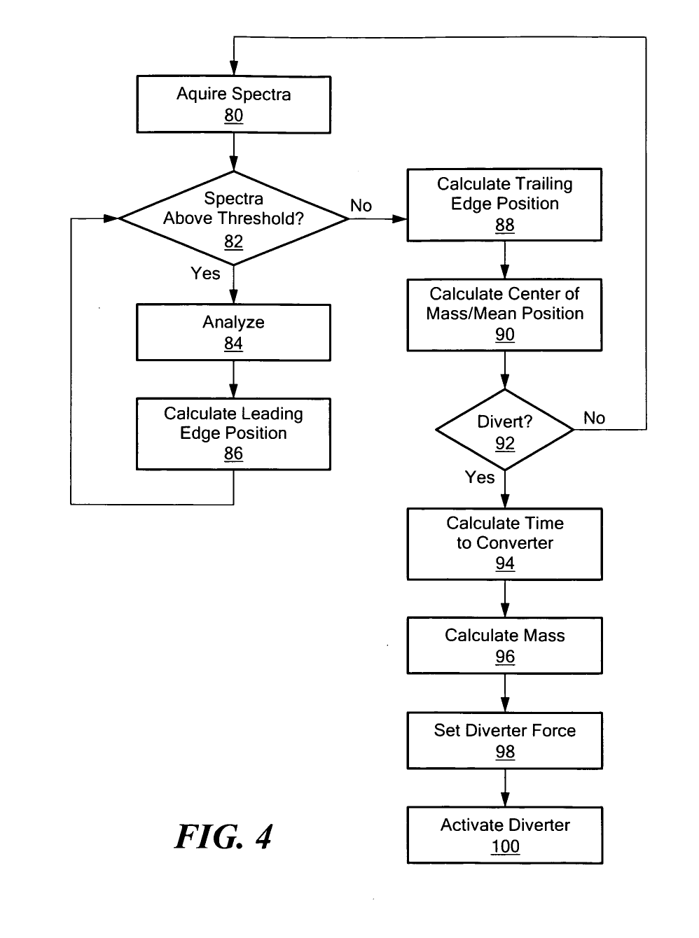

FIG. 4 shows how high speed digital processors/analyzer subsystem 64 is configured (e.g., programmed). Source 60, FIG. 3 and detector 62 are controlled to acquire spectra every 10 ms, step 80, FIG. 4. When spectra is acquired above a preset background threshold level, step 82, the leading edge of a piece of scrap metal has entered the x-ray excitation region on the conveyor and the high speed digital processor/analyzer acquires additional spectra in subsequent 5-10 ms time periods until an acquired spectrum is again not detected above the background level. The XRF spectra is analyzed to determine elements present and the relative concentrations based on measured peak intensities, step 84. From the leading edge position at step 86 and the trailing edge at step 88, the spectra data is used to calculate an approximate center of mass of the piece of material, step 90. An averaging technique may be used. Typically, the center of mass of the piece of material denotes an approximation of the mean position of the piece of material on the conveyor. At the very least, the extent of the scrap piece is now known as well as its location on the conveyor at a specific time including the particular lane or lanes occupied by the piece of scrap.

If the spectra indicates the presence of a material (e.g., copper) that is to be diverted from the main scrap stream as shown at step 92, the time it will reach the diverter paddle can be calculated based on its known position, the speed of the conveyor belt, and the distance between the known position and the individual diverter paddle, step 94. In this way, high speed digital processor/analyzer 64, FIG. 3 can signal diverter subsystem 26 to activate the appropriate paddle at the right time.

In addition, the mass of the meatball can also be approximated as shown at step 96, FIG. 4. Most scrap meatballs are roughly square in shape. From the leading edge and trailing edge data obtained from steps 86 and 88, the extent of the scrap piece can be calculated and cubed. With this estimate of the size of the piece of scrap, its mass can be estimated by multiplying the size of the piece by its density. The density can be a set quantity (e.g., 7,000 kg/m³ for iron) or it can be estimated using the spectra analysis derived at step 84.

Based on the mass of the piece, high speed digital processor/analyzer 64, FIG. 3 sets the diverter force, step 98, FIG. 4 and signals diverter subsystem 26, FIG. 3 to actuate the appropriate paddle at the correct force level at the correct time as discussed above.

Knowing the location of any material on a conveyance while it is undergoing XRF analysis is important for the correct and accurate diversion of the material. For the “meatball” example, the material pieces may be small and less than a pound in mass up to eight to ten inches in width and height and weigh up to fifteen pounds. These items are moving on conveyor belt 20, FIG. 2 at speeds of four to five feet per second. The material is diverted to secondary belt 30 generally moving perpendicular to main belt 20. It is thus important to control the trajectory of the material. The result is fast moving pieces of metal with a weight range of one to fifteen pounds that need to be diverted so they land in a particular location which may be diversion belt 30 no wider than three feet or so. The physics of such a situation make it important to know when the piece of material is exactly in the right spot in relation to diverter paddles 28a-28d and to have some idea of its approximate size. In this way, it can be diverted with the correct amount of force such that it is diverted the appropriate distance so that it lands on diverter belt 30. Given the speed of the material and the large difference in possible sizes and weights, the correct amount of force must be applied at just the right time to achieve precise diversion. Since the speed of belt 20 is known with fairly high accuracy, the time when the piece will arrive at the diverter subsystem 26 can be calculated and the appropriate diverter paddle or paddles 28a-28d activated with the correct force at the correct time.

The use of multiple high speed digital processors packaged with a detector and linked to a diverter paddle enables the analysis of a predetermined lane on the conveyor belt. Moreover, secondary sensors such as inductor sensors are typically not required as they do not provide sufficient precision. The leading edge, trailing edge DSP method of the subject invention provides better position location than could be attained using external sensors. External sensors fire when they sense a piece of metal moving past but have no ability to localize leading and trailing edges since the signal fades as the piece moves past the sensor rather than cutting off sharply. Also, for non-metal sorting applications, e.g., glass, plastic or wood, such sensors will not work since they are designed to detect metal pieces. The DSP and EDXRF method of the subject invention is thus a better option for localizing material location for non-metal samples. Successive spectra readouts while a piece of material is passing under detector 62, FIG. 3 can be used to determine the approximate center of mass and also to provide an overall estimate of the mass of the piece of material since it is known from the spectral analysis that the material is mostly iron. This additional data provides a better central location determination of the material and the knowledge of the mass allows the force of the diversion to be fine tuned for better diverting accuracy.

Note, however, that other means of conveyance and diversion are possible. In any embodiment, the subject invention provides a new automatic sorting system and method. It is particularly useful in the scrap metal industry but is not limited to such an application. The system operates reliably and can result in a very high throughput. The XRF analyzer subsystem is configured to detect fluoresced x-rays from an item being conveyed and to classify the item based on its fluoresced x-rays. Typically, in the scrap metal application, the classification includes determining whether copper is present in the item. The electronic processing subsystem is responsive to the XRF analysis subsystem and is configured to determine the extent of the item from its fluoresced x-rays and to activate a diverter subsystem based on both the classification and the extent of the item. Thus, the XRF spectrometer subsystem is used to analyze the scrap and to determine which items include an undesirable element or material and thus are to be diverted from the main waste stream. The XRF spectrometer subsystem data also is used to determine the position and even the size and mass of each piece of scrap to be diverted to better control the diverter subsystem to more reliably maintain the desired makeup of the waste stream.

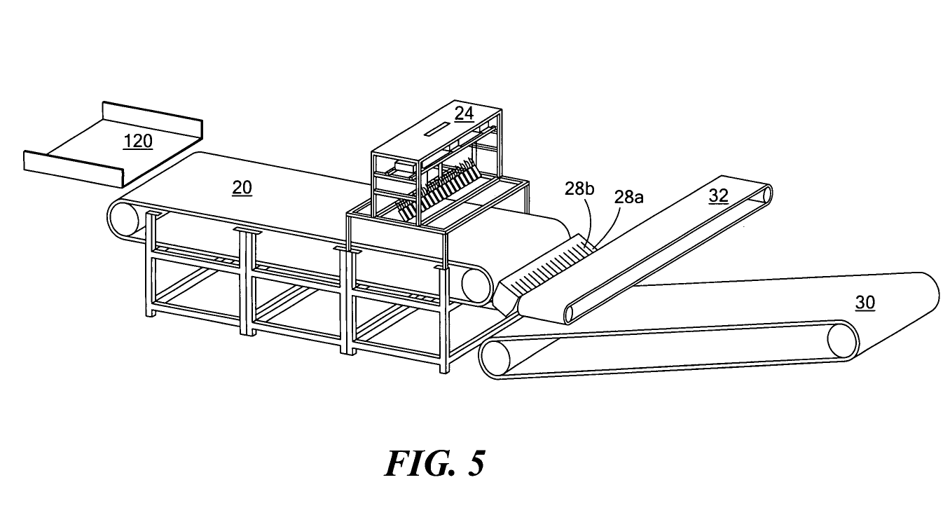

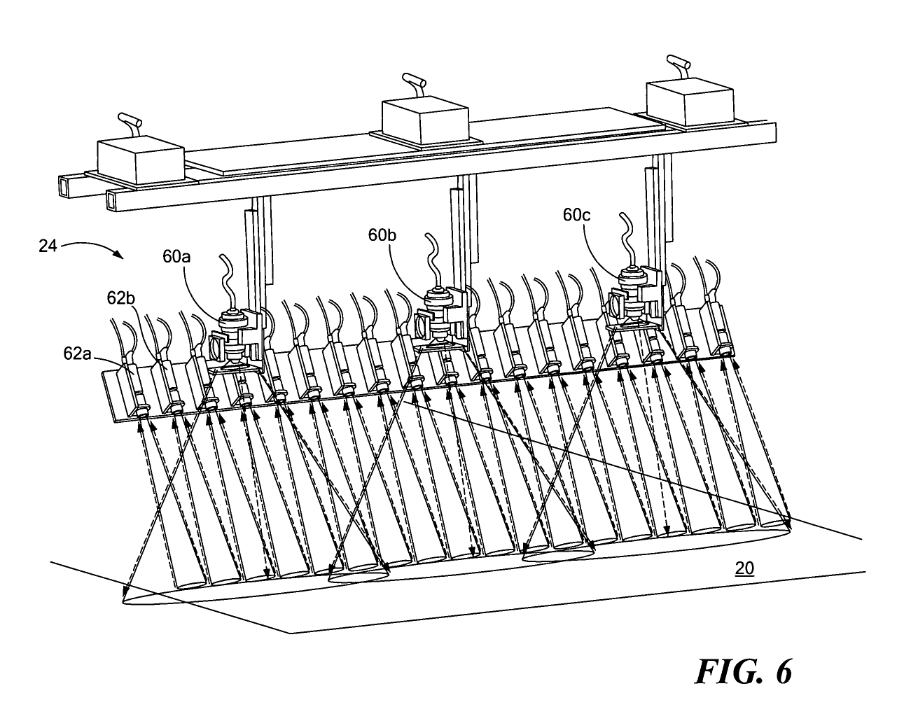

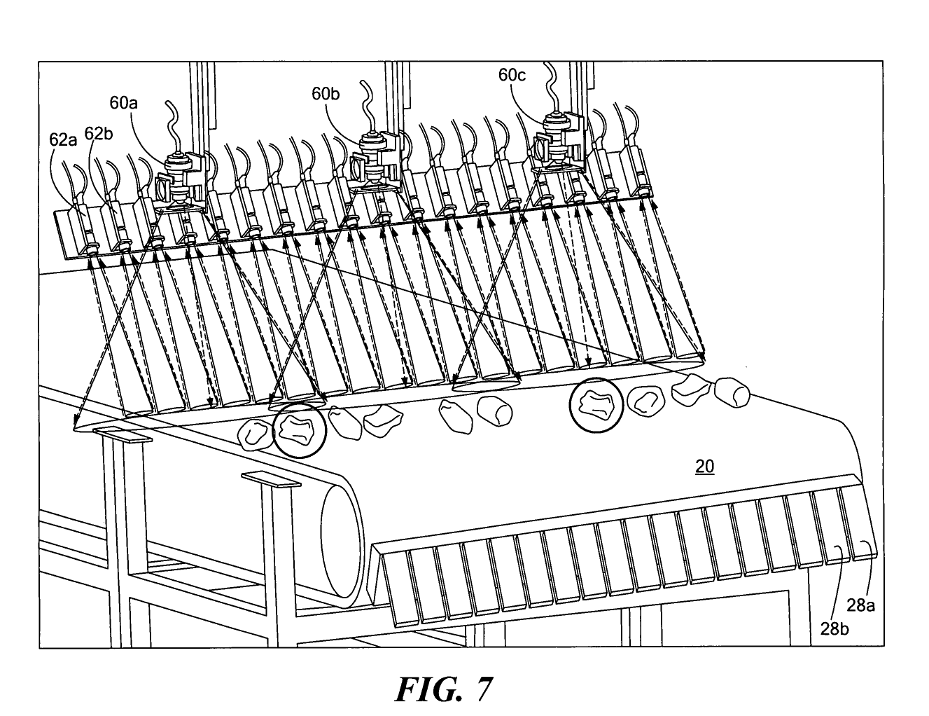

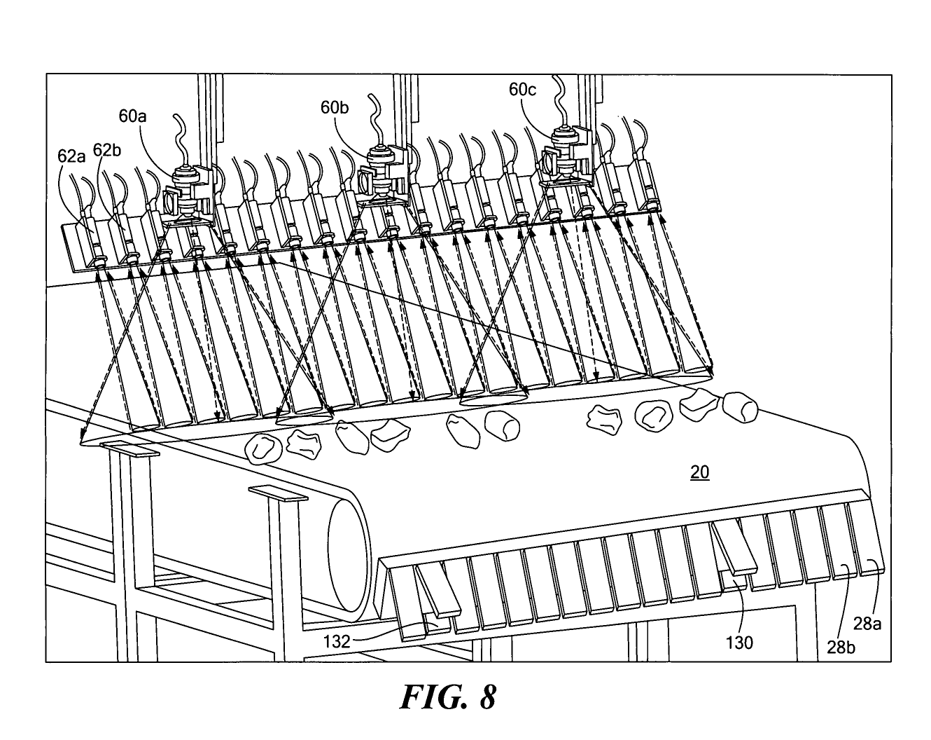

In one particular prototype example, the sorter system of FIG. 5 includes vibratory feeder 120 for feeding shredded scrap metal pieces onto conveyor belt 20. Feeder 120 provides lateral separation of the items. XRF subsystem 24 analyzes the scrap on belt 20 and controls diverter subsystem 26. Copper bearing meatballs are flipped by paddles 28a, 28b and the like onto belt 30 while other shredded material continues on stacking belt 32. XRF subsystem 24, FIG. 6 includes x-ray tubes 60a, 60b, and 60c, (e.g., Varian model V50). All the shredded material is irradiated as it passes under the tubes. There is typically one detector 62a, 62b, (e.g., Amptek) and the like per virtual lane. The detectors may be tuned to only read a signal emitted by copper. If the x-ray signal for copper is detected, that information is sent to the appropriate diverter paddle 28a, 28b and the like which is activated as shown at 130 and 132 in FIGS. 7-8. The copper bearing waste can also be collected an sold since copper has a high scrap value. The typical high speed processor/analyzer subsystem 64, FIG. 3 for each lane includes an Analog Devices “Blackfin” DSP.

Other prior automatic sorting systems such as x-ray transmission (XRT) or induction sorting systems (ISS) also sense a material property of each piece and divert it with a group of diverters. In order to properly localize the piece, and in order to know when to fire the diverter, however, prior systems typically use external sensors underneath the conveyor. For each “lane” there is one or more sensor. These sensors determine when a piece of metal passes by thus providing a rough estimate of the position of the piece of metal at a given location. If diversion is required, from the belt speed the system knows when it arrives at the diverter. XRT and ISS technologies, however, are less specific. For example, XRT performs a density measurement (much like a medical x-ray) to ascertain if the piece is a “light” or a “heavy” and diverts it accordingly. ISS typically determines if a piece of material has a magnetic moment or not, and the relative strength, thus determining if the piece is iron, or perhaps stainless or a different type of metal without being specific.

An energy-dispersive x-ray fluorescence (EDXRF) system in accordance with the subject invention is superior to ISS or XRT for many metal sorting applications because EDXRF is highly specific. The EDXRF system simultaneously measures 10+ elements in a piece of material (metal or non-metal). Thus, it can measure presence of copper in a piece of iron scrap to determine if it should be diverted, and an EDXRF system can measure Cr, Ni and Mo in a piece of metal to determine if it is a stainless steel and even if it is a 316 grade stainless versus a 304 grade stainless (the main difference being 2-3% Mo in 316, 0.7% max in 304).

Until now, EDXRF has not been a viable technology for the high-speed, automated sorting applications because of the time required to collect and analyze an x-ray spectrum has typically been 50-100 ms or longer. In that amount of time, the piece may have moved 3-6 inches or more. For a piece size that may be 0.5″ to have a position uncertainty of 3 inches or more, it was not previously possible to accurately divert the material to achieve commercially acceptable sorting accuracies.

One aspect of the subject invention is the novel use of EDXRF measurements combined with very high speed digital signal processors (DSPs) controlling the downstream diverters. In the preferred embodiment of the subject invention, the x-ray sources are continuously irradiating the moving conveyor. Each virtual lane includes a detector looking at x-rays from a lane of the belt, a digital signal processor (DSP) analyzing the energy spectrum from the detector, and a communications system that take a signal from a DSP to a dedicated diverter that is dedicated to a detector and DSP.

This DSP design examines spectral snapshots coming from the detector every 5-10 ms. When there is no piece present in the viewing area of the detector—which is the case 50% of time or more depending on the tons/hour of metal coming through—the DSP sees a spectrum typical of the bare conveyor. However, as a piece of metal moves into the viewing area of the detector, the leading edge produces a different spectrum—one that has peak intensities from iron, copper and/or other elements that are part of that piece of material. The “viewing area” is shown in FIG. 6 and is the conical volume emanating from a detector down to a lane on the conveyor. Note this is different, and smaller than, the source viewing area that is also shown in FIG. 6. The DSP design yields very fast measurements of these spectral snapshots, between 5-10 ms of irradiation time by the tube as the piece enters the viewing area. By detecting the leading edge of the piece to a position of 1 cm or less (a belt moving 5 fps is 150 cm/s times 0.005 is 0.75 cm), continuing to collect spectral data while the piece moves through the viewing area (this requires about 30-50 ms depending on belt speed), and then seeing the trailing edge of the piece, the EDXRF system obtains three critical pieces of information: (1) the approximate front edge of the piece, (2) the approximate trailing edge of the piece, and (3) spectra while the piece was moving through the viewing area. All of these 5-10 ms spectral snapshots are added together in the DSP processor. An additional benefit of this approach is that most of the spectral data is collected when a piece of material is in the viewing area instead of a lot of background spectra from the empty conveyor. The signal to background ratio is thus improved over other methods that do not use high speed DSP detection.

From the high speed DSP plus EDXRF measurements described above, the proposed method can thus localize the piece of material to within about 1 cm without the use of external sensors such as those used in ISS or XRT based systems. This is because the system of the subject invention has some knowledge of the front edge, rear edge and thus the length of the piece of material. From this information, an approximate central point (centroid) of the piece of material can be deduced. From these measurements, very high accuracy diversion can be obtained since the location of the centroid of the material is known, typically to within 1 cm or so.

The collected energy spectrum is of good statistical quality such that the detection accuracy (e.g., whether or not copper is present above a predetermined threshold level) is very high. This is because the DSP system has integrated multiple spectral snapshots of the material piece only when the piece is within the viewing area of the detector and thus has ignored spectral data from the empty conveyor. This improves the signal to background level and thus makes the detection accuracy far better.

Although specific features of the invention are shown in some drawings and not in others, however, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A sorting system comprising:
a conveyance for transporting items to be sorted at a predetermined speed;
an XRF spectrometer subsystem including:
at least one x-ray source directing x-ray energy at an item carried by the conveyance, and
a detector responsive to x-rays emitted by the item and producing a spectral signal characterizing the item, a leading edge of the item, and a trailing edge of the item;
a diverter subsystem downstream of the XRF subsystem for diverting sorted items; and
an electronic processing subsystem responsive to the detector signal and configured to determine if the item is to be diverted based on the elemental makeup of the item from its x-ray spectrum, the processing subsystem also configured to calculate the position of the item on the conveyance based on the detector signal and together with the predetermined speed of the conveyance controlling the diverter subsystem to divert selected items.

2. The sorting system of claim 1 in which the electronic processing subsystem is further configured to estimate the mass of the item.

3. The system of claim 2 in which the mass is estimated based on the size of the item which is estimated based on the leading and trailing edges of the item defining the extent of the item.

4. The system of claim 2 in which the diverter subsystem is configured to apply variable forces to items on the conveyance.

5. The system of claim 4 in which the electronic processing subsystem is further configured to control the force applied by the diversion subsystem to an item based on its mass.

6. The system of claim 1 in which the conveyance includes multiple virtual lanes for increasing the throughput of the system.

7. The system of claim 6 in which there is a diverter for each lane, a detector for each lane, and an electronic processing system for each lane for enhanced detection and diversion accuracy.

8. A sorting system comprising:
an XRF analyzer subsystem configured to detect fluoresced x-rays from an item being conveyed and to classify the item based on its fluoresced x-rays; and
an electronic processing subsystem responsive to the XRF analyzer subsystem and configured to determine the extent of the item from its fluoresced x-rays and to activate a diverter subsystem based on the classification at a time based in part on the extent of the item.

9. The sorting system of claim 8 in which the electronic processing subsystem is further configured to estimate the mass of the item based on its extent and to actuate the diverter subsystem based on the mass of the item.

10. A sorting system comprising:
a conveyor with multiple pieces of scrap metal thereon traveling in parallel with each other;
multiple diverters each defining a lane of the conveyor;
an XRF analyzer associated with each lane configured to detect fluoresced x-rays from an item being conveyed in a lane and to classify the item based on its fluoresced x-rays; and
an electronic processing subsystem associated with each lane and responsive to the XRF analyzer subsystem and configured to determine the extent of the item from its fluoresced x-rays and to activate one or more diverters based on the classification at a time based at least in part on the extent of the item.

11. A sorting method comprising:
conveying items to be sorted at a predetermined speed;
directing x-ray energy at an item being conveyed;
detecting x-rays emitted by the item and producing a spectral signal characterizing the item, a leading edge of the item, and a trailing edge of the item;
determining if the item is to be diverted based on its elemental make up determined from its x-ray spectrum;
calculating the position of the item being conveyed based on its x-ray spectrum together with the speed it is traveling; and
controlling one or more diverters to divert select items.

12. The method of claim 11 further including the step of estimating the mass of the item.

13. The method of claim 12 in which the mass is estimated based on the size of the item, which is estimated based on the leading and trailing edges of the item.

14. The method of claim 12 in which variable diverter forces are applied to different items being conveyed.

15. The method of claim 11 further including the step of transporting items in parallel multiple virtual lanes.

16. A sorting method comprising:
detecting fluoresced x-rays from an item being conveyed;
classifying the item based on its fluoresced x-rays;
determining the extent of the item from its fluoresced x-rays; and
diverting select items based on their classification and at a time based at least in part on their extent.

17. The method of claim 16 further including the step of estimating the mass of the item based on its extent and controlling the diversion of the item based on the mass of the item.

18. A sorting method comprising:
conveying multiple pieces of scrap metal in parallel on a conveyor;
associating an XRF analyzer with each lane of the conveyor and classifying each item in each lane based on its fluoresced x-rays;
determining the extent of each item in each lane from its fluoresced x-rays; and
activating a diverter subsystem based on the classification and at a time based at least in part on the extent of the item.
